(19) United States
(12) Patent Application Publication
(10) Pub. No.: US 2004/0195747 A1
(43) Pub. Date: Oct. 7, 2004

(54) Compact electric clamping device

(75) Inventor: Luciano Migliori, Milan (IT)

Correspondence Address: YOUNG & THOMPSON, 745 SOUTH 23RD STREET 2ND FLOOR, ARLINGTON, VA, 22202

(73) Assignee: UNIVER S.P.A., MILAN (IT)

(21) Appl. No.: 10/812,924

(22) Filed: Mar. 31, 2004

(30) Foreign Application Priority Data
Apr. 4, 2003 (IT) MI2003A 000668

(51) Int. Cl. B25B 1/10

(52) U.S. Cl. 269/32

(57) ABSTRACT

The clamping device for clamping work pieces comprises a box-shaped body, and an angularly movable clamping arm, operatively connected to an electric control actuator by a toggle-lever mechanism and an axially extensible thrust member. The toggle-lever mechanism comprises a connecting link having first and second link sections hinged on opposite sides of a crank member of the clamping arm, and to a screw and nut mechanism of the thrust member. The screw slides in an axial through bore which extends along the thrust member and through a hole in a hinge pin which connects the thrust member to the sections of the connecting link.

### BACKGROUND OF THE INVENTION

This invention relates to an electrically-controlled toggle-lever clamping device for clamping work pieces, used in particular in the automation and automotive fields for clamping sheet metal parts while they are being welded.

### STATE OF THE ART

In general, electrically-controlled toggle-lever clamping devices for clamping work pieces are widely known and described, for example by EP 0 255 853, EP 0 243 599 and EP 0 268 176.

In particular, EP 0 268 176, which represents the closest prior art, describes a clamping device of the aforementioned kind, comprising a box-shaped body having a longitudinal axis, and a clamping arm pivotally connected to the box-shaped body, the clamping arm being angularly movable between a first operative position and a second operative position in which it respectively releases and retains the work pieces.

The clamping arm is operatively connected to an electric control actuator by means of a toggle-lever mechanism and an axially extensible thrust member.

The toggle-lever mechanism comprises a crank rigidly connected to the clamping arm, and a connecting link hinged to the same crank and to a connecting rod of the axial thrust member.

The axial thrust member also comprises a nut screw coupled with the connecting rod, and a lead screw operatively connected to the control actuator, which extends through the nut screw, and an axial bore of the connecting rod.

To enable the clamping arm to move from the first to the second operative position, the thrust member must correpondingly move from a backward condition, in which the screw penetrates completely into the connecting rod, to a forward condition in which the screw is almost totally protruding from the connecting rod, while remaining partially engaged with the nut screw.

In correspondence with the aforesaid forward condition, the thrust member has a considerable axial extension, causing such a clamping device to necessarily present high overall axial dimensions, which result in installation difficulty into the working lines.

### OBJECTS OF THE INVENTION

The main object of this invention is to provide an electrically-controlled clamping device of the aforementioned kind, having reduced overall axial dimensions, while ensuring a wide angular movement of the clamping arm equal to that provided by conventional clamping devices.

Another object of this invention is to provide a clamping device of the above mentioned kind, which allows an easy installation, even in the case of working lines having limited working space.

### BRIEF DESCRIPTION OF THE INVENTION

The above can be achieved by means of a clamping device for clamping work pieces, of the type comprising:

a box-shaped body having a longitudinal axis;

a clamping arm pivotally connected to said box-shaped body to rotate between a first and a second angular position; and

an electric control actuator,

said clamping arm being operatively connected to the control actuator by means of a toggle-lever mechanism and an axially extensible thrust member;

the toggle-lever mechanism comprising a connecting link hinged to a crank member rigidly connected with the clamping arm and to a connecting rod of the axial thrust member,

the axial thrust member in turn comprising a lead screw operatively engaged with a nut screw coupled with the connecting rod, in which the lead screw extends through the nut screw and into an axial bore of the connecting rod,

characterised in that the connecting link comprises spaced apart first and second link sections disposed on respective opposite sides of the crank, and the thrust member connecting rod, said first and second sections of connecting link being connected to the rod of the thrust member by a transversely extending first hinge pin, and

in that the axial bore in the connecting rod extends along the entire length of the same connecting rod, the lead screw of the thrust member slidingly moving along the said axial bore and through a cross-hole in the aforesaid hinge pin.

### BRIEF DESCRIPTION OF THE DRAWINGS

These and further features according to this invention, will be more clearly evident from the following description with reference to the accompanying drawings, in which:

FIG. 1 shows a longitudinal sectional view of a clamping device according to the invention, along the line 1-1 of FIG. 2;

FIG. 2 shows a longitudinal sectional view of the device of FIG. 1, along the line 2-2 of FIG. 1;

FIG. 3 shows an enlarged detail of FIG. 2;

FIG. 4 shows an enlarged detail of FIG. 1;

FIG. 5 shows a cross-sectional view of the clamping device along the line 5-5 of FIG. 1.

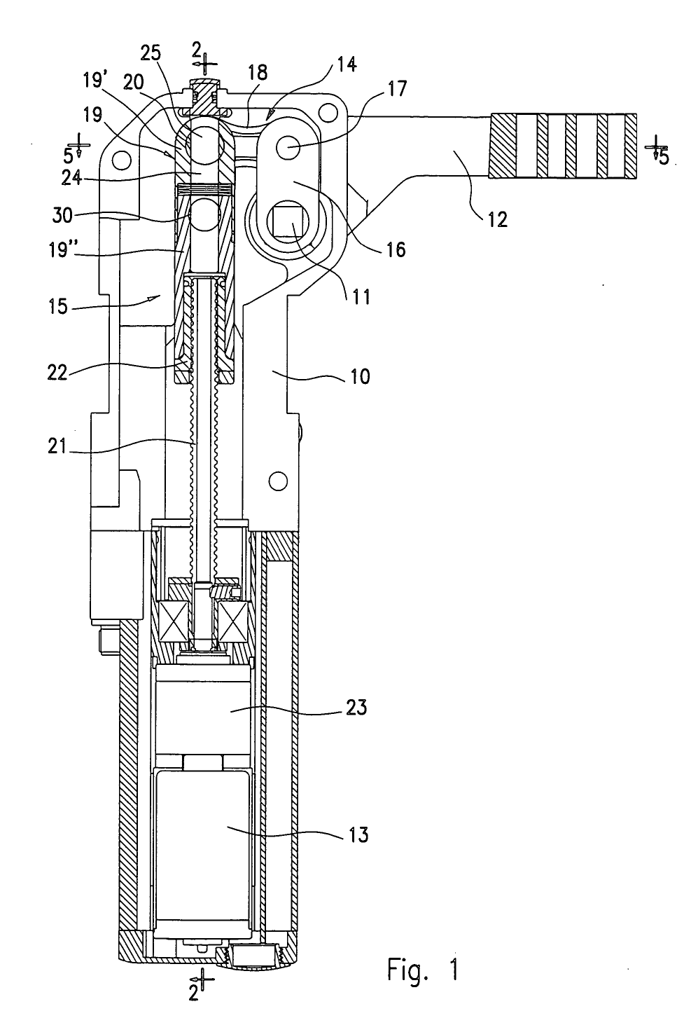

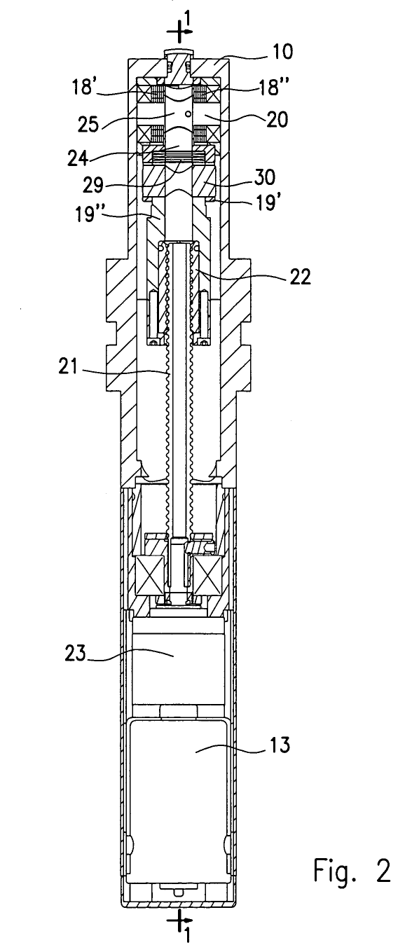

### DETAILED DESCRIPTION OF THE INVENTION

The general features of this invention will be illustrated hereunder by means of an exemplificative embodiment.

The toggle-lever clamping device according to the invention, shown in the figures from 1 to 5, comprises a box-shaped body 10, having a longitudinal axis, to which is connected a clamping arm 12 by a pivot shaft 11, the clamping arm 12 being angularly movable between a first operative releasing position and a second operative retaining position in which it respectively releases and retains a work piece.

The clamping arm is operatively connected to an electric control actuator 13 by means of a toggle-lever mechanism 14 and an axially extensible thrust member 15.

The toggle-lever mechanism 14 comprises a crank member 16, rigidly connected with the clamping arm 12 by the pivot shaft 11, and a connecting link 18 which is hinged in 17 with the same crank 16. Preferentially the connecting link 18 is of the axially controlled elastic yielding type.

The connecting link 18 is in turn hinged to a connecting rod 19 of the axial thrust member 15.

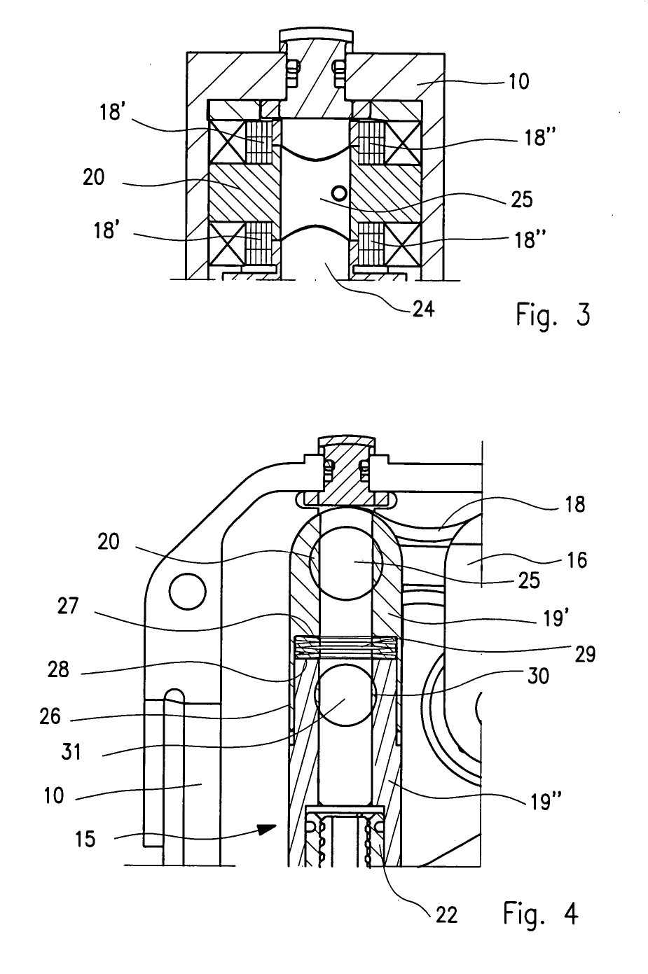

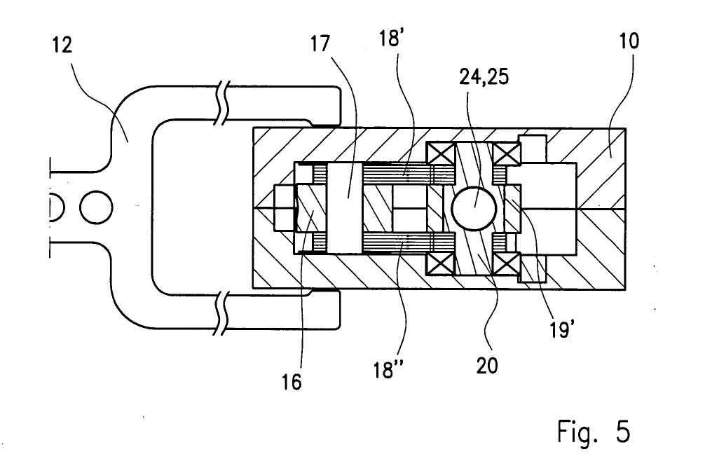

As shown in FIGS. 3 and 5, the connecting link 18 comprises spaced apart first and second connecting link sections 18′, 18″ disposed on respective opposite sides of the crank 16 and the thrust-member connecting rod 19.

Said connecting link sections 18′ and 18″ are connected to the rod 19 of the thrust member 15 by a transversal extending first hinge pin 20, and comprise for example a plurality of side by side arranged plates, capable of reducing the stresses in the same connecting link 18.

The axial thrust member 15 comprises a lead screw 21, which extends and operatively engages with a nut screw 22 coupled with the connecting rod 19 of the aforesaid thrust member 15.

The lead screw 21 is in turn connected to the electric control actuator 13, in particular an electric motor, preferentially by means of a reduction unit 23, for example of the epicycloidal type.

To enable the clamping arm 12 to angularly move from the first to the second operative position, the thrust member 15 must extend from a backward condition, in which the lead screw 21 penetrates completely into an axial bore 24 in the connecting rod 19, to a forward condition in which the screw 21 is almost totally protruding from the connecting rod 19, while remaining at least partially engaged with the nut screw 22.

The clamping device according to the invention, in order to have reduced axial overall dimensions, is made in such a way that the axial bore 24 in the connecting rod 19 extends along the entire length of the same connecting rod 19; in this way the lead screw 21 of the thrust member 15 can slidingly move along the axial bore 24, extending furtherly through a cross hole 25 in the hinge knuckle pin 20.

In this way, it is possible to considerably reduce the axial dimensions of the device, in that, with the same axial elongation of the thrust member 15 and correspondingly with the same angular movement of the clamping arm 12, the thrust member 15 is of more limited dimensions in the axial direction.

In fact, since the axial elongation of the thrust member 15 is equivalent to the length of the lead screw portion which is extracted from the connecting rod 19, the connecting rod 19 can be of a shorter length compared to a conventional solution, in that the lead screw 21 in correspondence with its backward position can slide along the entire connecting rod 19 and through the hinge pin 20, unlike the conventional connecting rods.

The thrust member rod 19 can comprise a single connecting element pivotally connected to the connecting link 18 and coupled with the nut screw 22, or preferentially, the connecting rod 19 comprises a first rod portion 19′ pivotally connected to the connecting link 18 and a second rod portion 19″ for housing the nut screw 22.

The second rod portion 19″ are axially movable in respect to the first rod portion 19′ of the connecting rod 19; for example the first rod portion 19′ can be provided with a bell-shaped end 26 into which can be slidingly fitted an end of the second rod portion 19″.

The first and the second rod portion 19′, 19″ have respective opposing shoulder surfaces 27, 28 between which elastically yieldable biasing means are disposed, such as for example Belleville washers 29, in order to take up the internal slack and decrease the stress on inner members of the device.

The two rod portions 19′, 19″ are slidingly connected to each other by a second pin member 30 having a cross hole 31 for the passage of the lead screw 21 of the thrust member 15.

The second pin member 30 extends into axially aligned through holes in the first end second rod portions 19′, 19″ of the connecting rod 19.

The relative axial sliding movement between the two rod portions 19′, 19″ is allowed in that the through holes of one of the rod portions 19′, 19″ extends in the axial direction of the thrust member 15, in order to allow the pin 30 to shift slightly in such direction.

The constructional solution according to the invention allowing to reduce the axial overall dimensions of a clamping device provided with a rotating arm, can also be applied to other types of clamping devices, for example to a clamping device having a retaining member in the form of an axially movable hook member and a centring pin for centring the work pieces.

Consequently, the expression “clamping device” is understood to indicate any toggle-lever clamping device with one or more rotating clamping arms, or a clamping device comprising one or more axially movable hook-shaped members and a centring pin for centring work pieces.

What has been described and shown with reference to the accompanying drawings has been given purely by way of example in order to illustrate the general features of the invention, and of one of its preferential embodiments; therefore, other modifications and variations to the clamping device are possible, without thereby departing from the scope of the claims.

What we claim is:

1. Clamping device for clamping work pieces, of the type comprising:
a box-shaped body having a longitudinal axis;
a clamping arm pivotally connected to said box-shaped body to rotate between a first and a second angular position; and
an electric control actuator,
said clamping arm being operatively connected to the control actuator by means of a toggle-lever mechanism and an axially extensible thrust member;
the toggle-lever mechanism comprising a connecting link hinged to a crank member rigidly connected with the clamping arm and to a connecting rod of the axial thrust member,
the axial thrust member in turn comprising a lead screw operatively engaged with a nut screw coupled with the connecting rod, in which the lead screw extends through the nut screw and into an axial bore of the connecting rod,
characterised in that the connecting link comprises spaced apart first and second link sections disposed on respective opposite sides of the crank, and the thrust member connecting rod, said first and second sections of connecting link being connected to the rod of the thrust member by a transversely extending first hinge pin, and
in that the axial bore in the connecting rod extends along the entire length of the same connecting rod, the lead screw of the thrust member slidingly moving along the said axial bore and through a cross-hole in the aforesaid hinge pin.

2. Clamping device according to claim 1, characterised in that the rod of the thrust member comprises of a single connecting element pivotally connected to the connecting link and coupled with the nut screw of the thrust member.

3. Clamping device according to claim 1, characterised in that the connecting rod of the thrust member comprises a first rod portion pivotally connected to the connecting link, and a second rod portion for housing the nut screw, said second rod portion being axially movable in respect to the first rod portion of the connecting rod, and elastically yieldable biasing means being disposed between shoulder surfaces of said first and second portions of the connecting rod.

4. Clamping device according to claim 3, characterised in that a second pin member is extanding into axially aligned through holes in said first and second rod portions of the connecting rod, the through holes of one of said first and second rod portions extending in the axial direction of thrust member of clamping device.

5. Clamping device according to claim 4, characterised in that said second pin member comprises a cross hole for the passage of the lead screw of the thrust member.
